(19) United States
(12) Patent Application Publication
(10) Pub. No.: US 2008/0184152 A1
(43) Pub. Date: Jul. 31, 2008

(54) SYSTEM AND METHOD FOR HISTORICAL TASK SEQUENCE PROGRESS TRACKING

(76) Inventor: Marianne KODIMER, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/736,977

(22) Filed: Apr. 18, 2007

Related U.S. Application Data
(60) Provisional application No. 60/886,835, filed on Jan. 26, 2007.

(51) Int. Cl. G06F 3/048

(52) U.S. Cl. 715/772

(57) ABSTRACT

The subject application is directed to a system and method for task sequence progress tracking. Following the receipt of data representative of a multi-step document processing operation to be performed on an associated electronic document a linear display is generated including multiple segments. Each segment corresponds to a specific step of the multi-step processing operation. The appearance of segments in the linear display is changed in accordance with progress of the processing operation. The segments in the linear display representing a future step, a current step, and a completed step, have different appearances. Therefore, the user is always oriented to where he is at in a multiple step process and knows how many steps remain.

### CROSS-REFERENCE TO RELATED APPLICATIONS

This applications claims priority to U.S. Provisional Patent Application Ser. No. 60/886,835, filed Jan. 26, 2007, titled “A SYSTEM AND METHOD FOR GRAPHICALLY ORIENTING A USER IN A MULTI-STEP OPERATION”, the entirety of which is incorporated herein.

### BACKGROUND OF THE INVENTION

The subject application is directed to a system and method for generating a user interface for an operation that involves multiple steps. More particularly, the subject application is directed to a system and method for task sequence progress tracking, which allows for efficiently and effectively displaying on a graphical display a chain of steps with emphasis on the step, the user is currently interacting.

Document processing typically involves the use of a user interface to allow for selection and control various tasks and functions. By way of example, office machines, such as copiers, printers, scanners, or facsimile machines, as well as multifunction peripherals that include more than one of these functions, typically employ a keyboard and display or a touch screen display. Conventionally, a user is presented a screen of options for a single step of a multiple step process one step at a time. For example, the process of making copies may involve the steps of selecting options, selecting number of copies, placing documents, reviewing thumbnails, and printing the copies. Typically, a user would have to go to different hierarchical menus to complete each step. Complex functions frequently require forward, or forward and backward, navigation among various hierarchical levels.

### SUMMARY OF THE INVENTION

In accordance with one embodiment of the subject application, there is provided a system and method for task sequence progress tracking.

Further, in accordance with one embodiment of the subject application, there is provided a system and method for graphically orienting a user in a multi-step operation.

Still further, in accordance with one embodiment of the subject application, there is provided a system and method for task sequence progress tracking to be used in document processing operations.

Further, in accordance with the subject application, there is provided a task sequence progress tracking system. The system includes means adapted for receiving data representative of a multi-step document processing operation to be performed on an associated electronic document and means adapted for receiving, from an associated document processing device, progress data representative of progress of the multi-step document processing operation on the associated electronic document. The system further includes a linear display having a plurality of segments. Each segment of the display corresponds to a step of a multi-step document processing operation. Each segment has an associated indicia representative of a step associated therewith. Also included in the system is means adapted for toggling an appearance of each segment from a first state, representative of a future step, to a second state representative of a current step, to a third state representative of a completed step. The toggling is in accordance with received progress data.

In one embodiment of the subject application, the first state is a base level, the second state is a highlighted level and the third state is a dimmed level. The levels are such that an appearance of a segment in first state is dominated by an appearance of a segment in the third state and wherein an appearance of a segment in the second state is dominated by an appearance of a segment in the first state.

In another embodiment of the subject application, each indicia includes a verbal description of an associated step.

In yet another embodiment of the subject application, the progress data is generated by an associated user engaging the series of steps.

In further embodiment of the subject application, the progress data is generated automatically by operation of the associated document processing device.

In one embodiment of the subject application, the system also includes means adapted for selectively altering an appearance of at least one portion of a segment in accordance with progress through its associated step.

Still further, in accordance with one embodiment of the subject application, there is provided a method for task sequence progress tracking in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject invention is described with reference to certain figures, including:

FIG. 1 is an overall diagram of the task sequence progress tracking system according to one embodiment of the subject application;

FIG. 2 is a block diagram illustrating device hardware for use in the task sequence progress tracking system according to one embodiment of the subject application;

FIG. 3 is a functional block diagram of the device driver for use in the task sequence progress tracking system according to one embodiment of the subject application;

FIG. 4 is a block diagram illustrating controller hardware for use in the task sequence progress tracking system according to one embodiment of the subject application;

FIG. 5 is a functional block diagram of the controller for use in the task sequence progress tracking system according to one embodiment of the subject application;

FIG. 6 illustrated is a sample graphical user interface including a linear display having multiple segments according to one embodiment of the subject application;

FIG. 7 is a flowchart illustrating the method for task sequence progress tracking according to one embodiment of the subject application;

FIG. 8 is a flowchart illustrating the method for task sequence progress tracking according to one embodiment of the subject application;

FIG. 9 is a flowchart illustrating the method for task sequence progress tracking according to one embodiment of the subject application; and

FIG. 10 is a flowchart illustrating the method for task sequence progress tracking according to one embodiment of the subject application.

### DETAILED DESCRIPTION OF THE PREFERRED EMBODIMENT

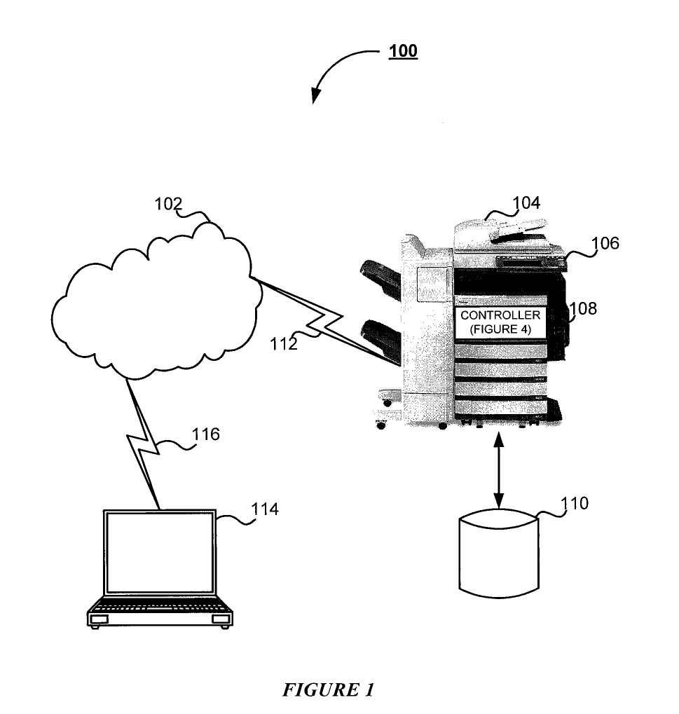

The subject application is directed to a system and method for task sequence progress tracking. In particular, the subject application is directed to generating a user interface for an operation that involves multiple steps. More particularly, the subject application is directed to a system and method for task sequence progress tracking, which allows for efficiently and effectively displaying on a graphical display a chain of steps with emphasis on the step, the user is currently interacting. It will become apparent to those skilled in the art that the system and method described herein are suitably adapted to a plurality of varying electronic fields employing user interfaces that require more than one step of user interaction, including, for example and without limitation, communications, general computing, data processing, document processing, or the like. The preferred embodiment, as depicted in FIG. 1, illustrates a document processing field for example purposes only, and is not a limitation of the subject application solely to such a field.

Turning now to FIG. 1, there is shown an overall diagram of the system 100 for task sequence progress tracking in accordance with the subject application. As shown in FIG. 1, the system 100 employs a distributed computing environment, represented as a computer network 102. It will be appreciated by those skilled in the art that the computer network 102 is any distributed communications environment known in the art capable of enabling the exchange of data between two or more electronic devices. Those skilled in the art will further appreciate that the network 102 is any computer network known in the art including, for example and without limitation, a virtual area network, a local area network, a personal area network, the Internet, an intranet, a wide area network, or any suitable combination thereof. Preferably, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms.

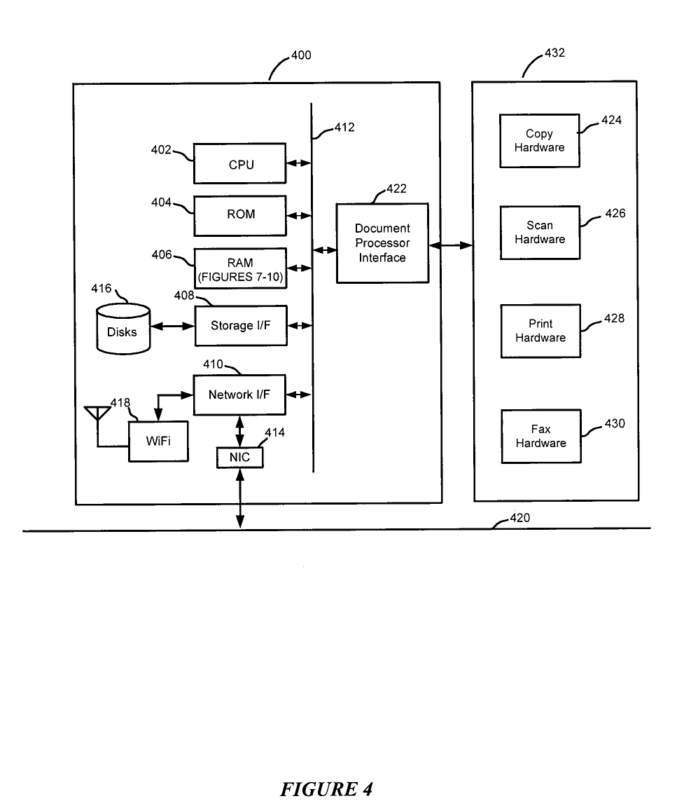

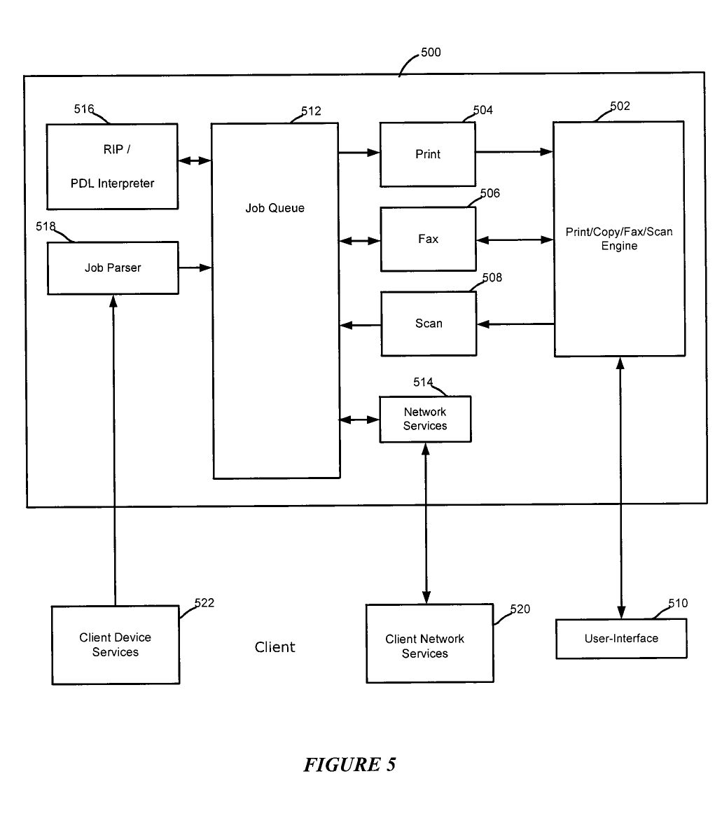

The system 100 depicted in FIG. 1 further includes a document processing device 104, represented as a multifunction peripheral device, suitably adapted to perform a variety of document processing operations. The skilled artisan will understand that such document processing operations include, for example and without limitation, copying, scanning, electronic mail, document management, facsimile, printing, and the like. Suitable commercially available document processing devices include, but are not limited to, the Toshiba e-Studio Series Controller. In one embodiment, the document processing device 104 is suitably equipped to receive a plurality of portable storage media, including without limitation, Firewire drive, USB drive, SD, MMC, XD, Compact Flash, Memory Stick, and the like. In the preferred embodiment of the subject application, the document processing device 104 further includes an associated user-interface 106, such as a touch-screen interface, an alpha-numeric interface, an LCD display, or the like, via which an associated user is able to interact directly with the document processing device 104. Preferably, the user-interface 106 is suitably adapted to display a graphical user interface associated with the operation of the document processing device 104. The functioning of the document processing device 104 will be better understood in conjunction with the block diagrams illustrated in FIGS. 4 and 5, explained in greater detail below.

In accordance with the subject application, the document processing device 104 further incorporates a controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, control the display of images via the user-interface 106, customize a graphical user interface, and the like. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store information relative to the customized user-interface screens, home pages, settings, or the like, associated with a particular user's identification information. In addition, the data storage device 110 is further capable of storing some or all of a particular customized graphical user-interface associated with an individual user. It will be appreciated by those skilled in the art that while illustrated in FIG. 1 as being a separate component of the system 100, the data storage device 110 is capable of being implemented as internal storage of the document processing device 104, such as, for example and without limitation, an internal hard disk drive, or the like.

Preferably, the document processing device 104 is communicatively coupled to the computer network via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

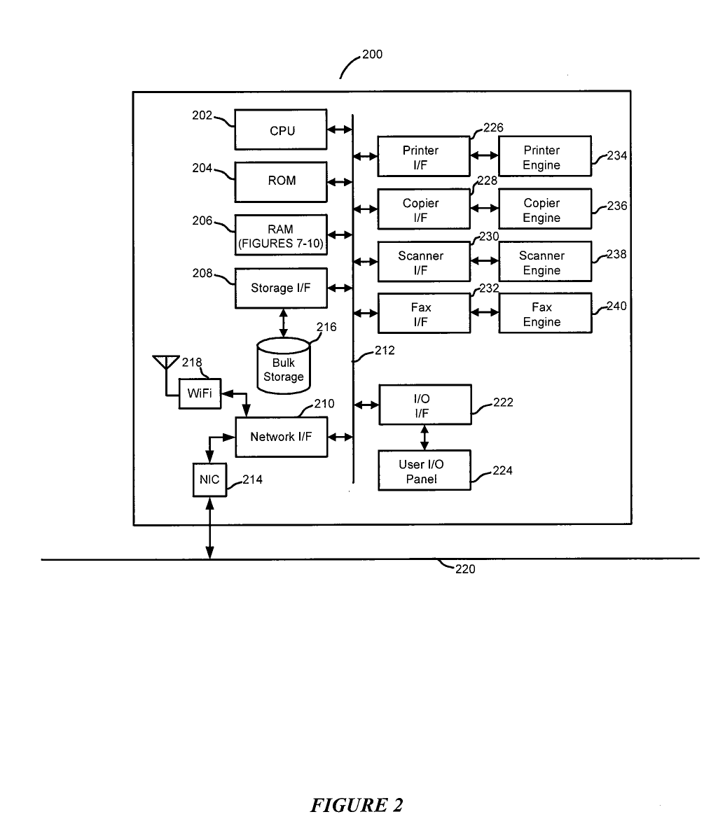

Turning now to FIG. 2, illustrated is a representative architecture of a suitable device 200 on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

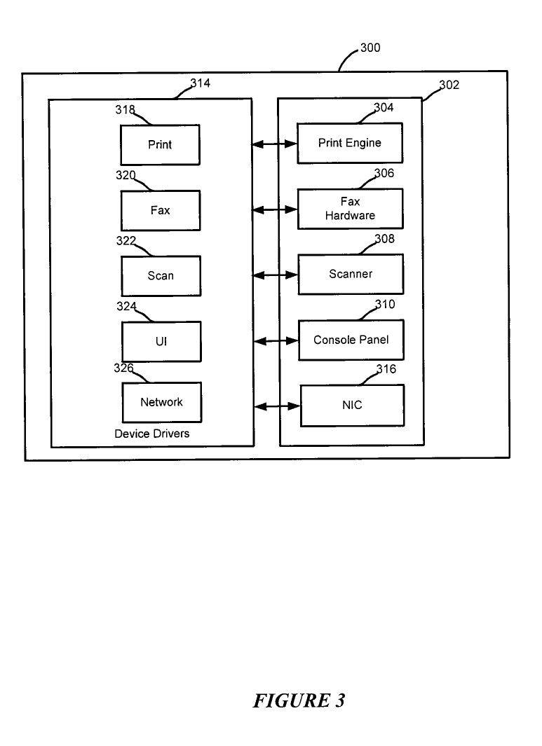

Turning now to FIG. 3, illustrated is a suitable document processing device for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable controller 400, shown in FIG. 1 as the controller 108, on which operations of the subject system 100 are completed. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. Network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and network interface subsystem 410 is suitably accomplished via a bus data transfer mechanism, such as illustrated by bus 412.

Also in data communication with the bus 412 is a document processor interface 422. The document processor interface 422 suitably provides connection with hardware to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system is accomplished on a suitable document processing device 104 that includes the controller 400 of FIG. 4 as an intelligent subsystem associated with a document processing device. In the illustration of FIG. 5, controller function 500 in the preferred embodiment includes a document processing engine 502. A suitable controller functionality is that which is incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably via an interface local to the controller, or remotely via a remote thin or thick client.

The engine 502 is in data communication with printer function 504, facsimile function 506, and scan function 508. These devices facilitate the actual operation of printing, facsimile transmission and reception, and document scanning for use in securing document images for copying or generating electronic versions.

A job queue 512 is suitably in data communication with printer function 504, facsimile function 506, and scan function 508. It will be appreciated that various image forms, such as bit map, page description language or vector format, and the like, are suitably relayed from scan function 508 for subsequent handling via job queue 512.

The job queue 512 is also in data communication with network services 514. In a preferred embodiment, job control, status data, or electronic document data is exchanged between job queue 512 and network services 514. Thus, suitable interface is provided for network based access to the controller 500 via client side network services 340, which is any suitable thin or thick client. In the preferred embodiment, the web services access is suitably accomplished via a hypertext transfer protocol, file transfer protocol, uniform data diagram protocol, or any other suitable exchange mechanism. Network services 514 also advantageously supplies data interchange with client side services 340 for communication via FTP, electronic mail, TELNET, or the like. Thus, the controller function 500 facilitates output or receipt of electronic document and user information via various network access mechanisms.

Job queue 512 is also advantageously placed in data communication with an image processor 516. Image processor 516 is suitably a raster image process, page description language interpreter or any suitable mechanism for interchange of an electronic document to a format better suited for interchange with device services such as printing 504, facsimile 506 or scanning 508.

Finally, job queue 512 is in data communication with a parser 518, which parser suitably functions to receive print job language files from an external device, such as client device services 522. Client device services 522 suitably include printing, facsimile transmission, or other suitable input of an electronic document for which handling by the controller function 500 is advantageous. Parser 518 functions to interpret a received electronic document file and relay it to a job queue 512 for handling in connection with the afore-described functionality and components.

In operation, data representative of a multi-step document processing operation to be performed on an associated electronic document is first received. Next, progress data representative of progress of the multi-step document processing operation on the associated electronic document, is received from an associated document processing device. A linear display having multiple segments is then generated. Each segment of the linear display corresponds to a step of a multi-step document processing operation, wherein each segment has an associated indicia representative of a step associated with it. Once the linear display is generated, an appearance of each segment is toggled from a first state to a second state and to a third state. The first state is representative of a completed step, the second state is representative of a future step, and the third state is representative of a current step. The toggling is performed in accordance with received progress data.

In accordance with one example embodiment of the subject application, the controller 108 associated with the document processing device 104 receives data representative of a multi-step document processing operation to be performed on an associated electronic document. Those skilled in the art will recognize that data representative of a multi-step document processing operation is capable of being received via the user-interface 106, as an operation request from an associated user. The associated user is then prompted to input information for the first step via the user-interface 106. Preferably, the operation corresponds to a base function or service capable of performance by the associated document processing device 104, including, for example and without limitation, scanning, facsimile, copying, printing, electronic mailing, or the like. The skilled artisan will appreciate that these operations are often operations that involve the user interfacing with the controller 108 in multiple steps associated with the document processing device 104, wherein each operation has one or more subsequent steps corresponding to further associated services, options, or the like that may require additional user options to be entered.

As will be appreciated by those skilled in the art, the controller 108, prior to receiving data representative of a multi-step document processing operation, is capable of receiving login data from an associated user via the user-interface 106. Preferably, if the login mode is implemented the login data includes, for example and without limitation, a user ID/password, biometric data, personal identification number, a smart card, or the like.

Progress data representative of progress of the multi-step document processing operation on the associated electronic document is then received by the controller 108 associated with the document processing device 104.

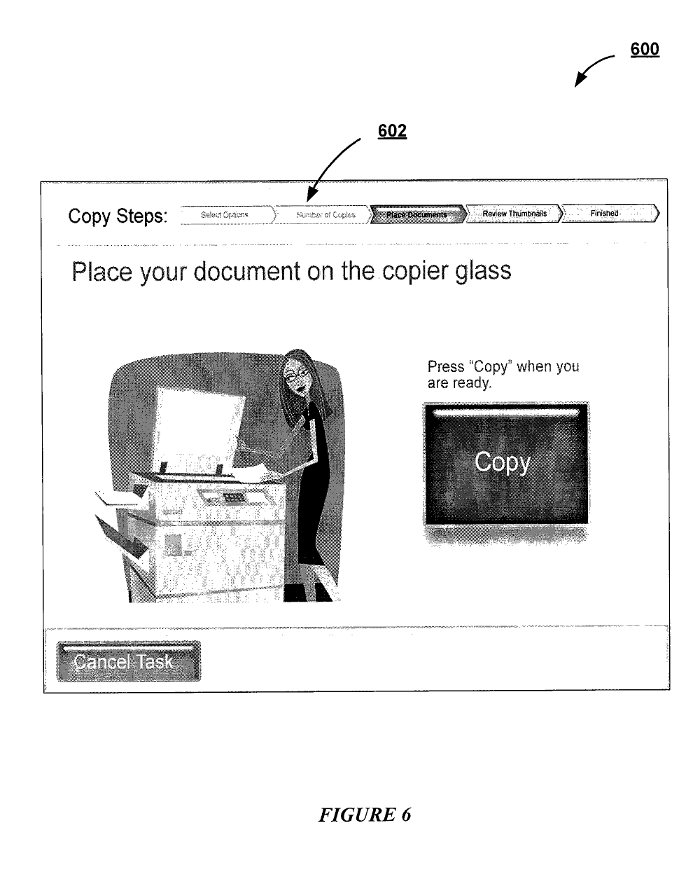

Next, a linear display having multiple segments is generated that displays all the steps required for completing the selected operation. That is, the controller 108 determines the step being performed and displays a graphical representation of the steps on the user-interface 106. Each segment has an associated indicia representative of a step associated therewith. Illustrated in FIG. 6 is an example display in accordance with the subject application, in which the linear display band 602 has five segments associated with corresponding steps involved with the operation to make copies: Selected Options, Number of Copies, Place Documents, Review Thumbnails, and Finished. As will be recognized by those skilled in the art, the multiple segment display is capable of being in any other graphical form, without limiting the scope of the subject application.

As data representative of progress of the multi-step document processing operation is received, the controller 108 toggles the appearance of corresponding segments of the linear display. Thus, an appearance of a segment, representative of a first state, such as a future step, differs from an appearance of a segment, representative of a second state, such as a current step, and differs from an appearance of a segment, representative of third state, such as a completed step. Toggling of the appearance of the linear display segments is provided in accordance with progress data received by the controller 108.

In accordance with one example embodiment of the subject application, one of the states, such as the first state, is a base level, the second state is a highlighted level, and the third state is a dimmed level. Thus, an appearance of a segment in the first state is dominated by an appearance of a segment in the third state and wherein an appearance of a segment in the second state is dominated by an appearance of a segment in the first state, as illustrated in FIG. 6.

Once the associated user completes a step, the controller 108 moves the highlighting or other marker to the next segment in the linear display band 602, associated with the next step. When the highlighting or marker is moved, the previous steps are still shown along with the steps that still need to be completed, allowing the user to know exactly where he is in the operation. Once the user completes the next step, the controller 108 moves the highlighting in the linear display band 602, or other marking indicating what operation step the user is on, to the next step on the linear display band 602 indicating the next step that the user needs to perform. This process proceeds until the user has completed all steps and the operation is completed.

In accordance with another example embodiment of the subject application, each indicia associated with a corresponding segment, includes a verbal description of an associated step, such as illustrated in FIG. 6.

As will be appreciated by those skilled in the art, the progress data is capable of being generated by an associated user engaging the series of steps. The progress data is also capable of being generated automatically by operation of the associated document processing device 104.

In one embodiment of the subject application, the selection of an operation is capable of being performed from a remote user device. For example, rather than request an operation at the document processing device 104, the user is able to select it from the user device 114, such as, for example, a notebook computer, attached to the network 102. When an operation is selected from the user device 114, the controller 108 of the document processing device 104 will communicate with the user device 114 via the network 102. The user device 114 will prompt the user with a display menu similar to that shown as the linear display band 602 in FIG. 6. When the user prompting is completed, the document processing device 104 will perform the operation.

In another embodiment of the subject application, the operation selected by the associated user is capable of including too many steps for effectively displaying them in a single linear display band 602 within the graphical user-interface 106. In such embodiment, a subset of the operation steps is presented the user. For example, the current step the user is interfacing will be displayed in the linear display band 602 along with a subset of the previous steps and a subset of the uncompleted steps. The number of previous and uncompleted steps shown will depend on how many steps are needed to effectively orient the associated user within the operation being performed. In this embodiment, the controller 108 changes the appearance of the display segments of the subset indicating the operation steps, in accordance with progress through its associated step.

In accordance with another embodiment of the subject application, the controller 108 is capable of determining that the associated user has abandoned an operation by detecting a predefined interval of no user activity, or interruption by any other means. The controller 108 then determines whether the user inputs from the completed steps are capable of being stored for completion at a later time. If the data prior to interruption is capable of being stored, the data corresponding to all steps completed by the user is thereafter stored by the document processing device 104 in the data storage device 110. Preferably, the operation data is stored in association with the user login information. The skilled artisan will appreciate that not all operations are capable of being interrupted and restarted in the same place. For example, if a document needs to be placed in the copier in a step prior to where the interruptions occurred then it will not be possible to restart from the step where the interruption occurred. In those situations, the controller 108 is capable of electing not to direct the completed steps to be saved in the storage means 110. Alternatively, if the steps could be restarted from an earlier step, which is not the first step, then the controller 108 will direct the completed steps to be saved in the storage means 110, so that the operation is able to be restarted at a step that would allow the correct completion of the operation.

Thus, the skilled artisan will appreciate that at subsequent logons by the user the controller 108 will access the data storage device 110 and display the linear display band 602, as well as the step where the previous operation was interrupted in the graphical user interface 106 display. This enables the user to efficiently complete the desired operation, without repeating completed steps.

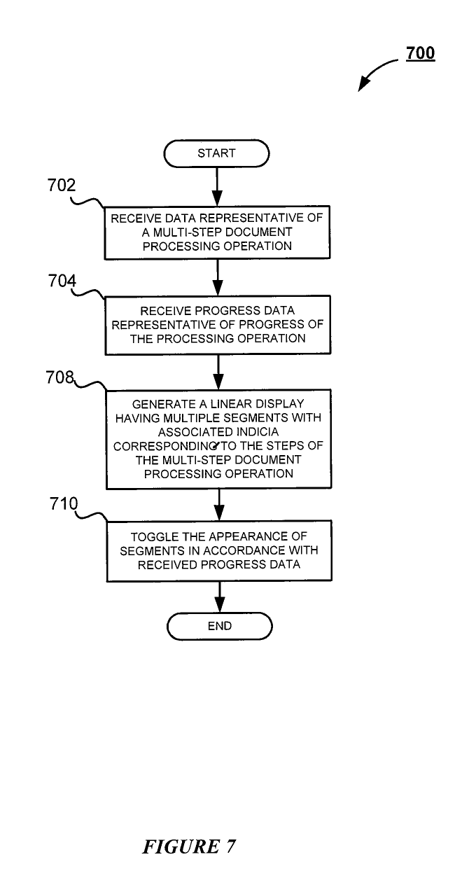

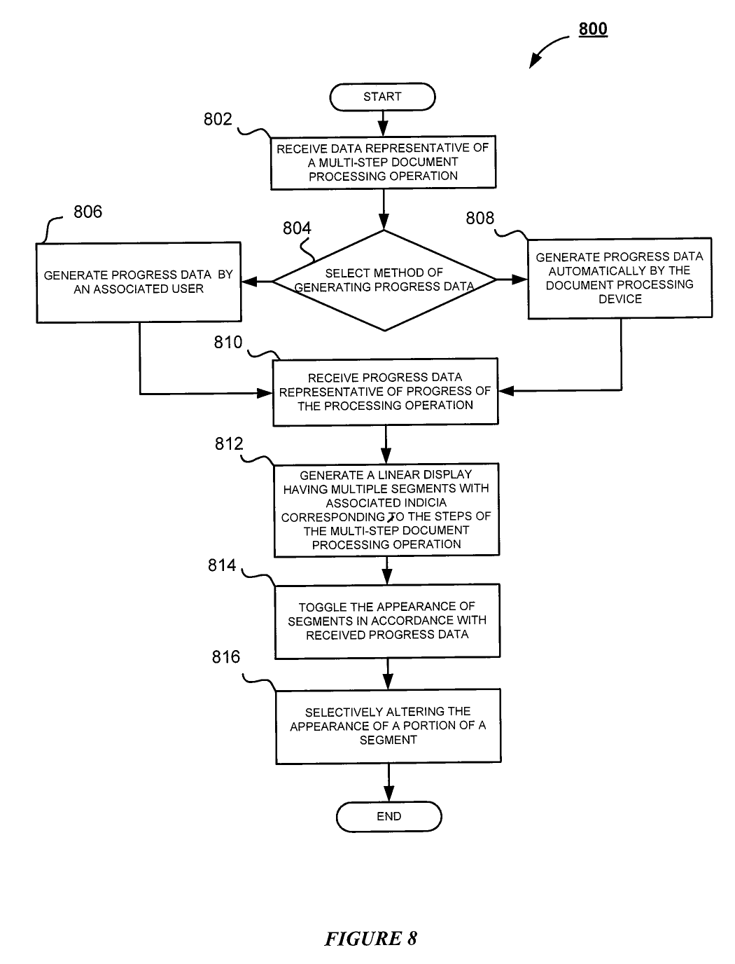

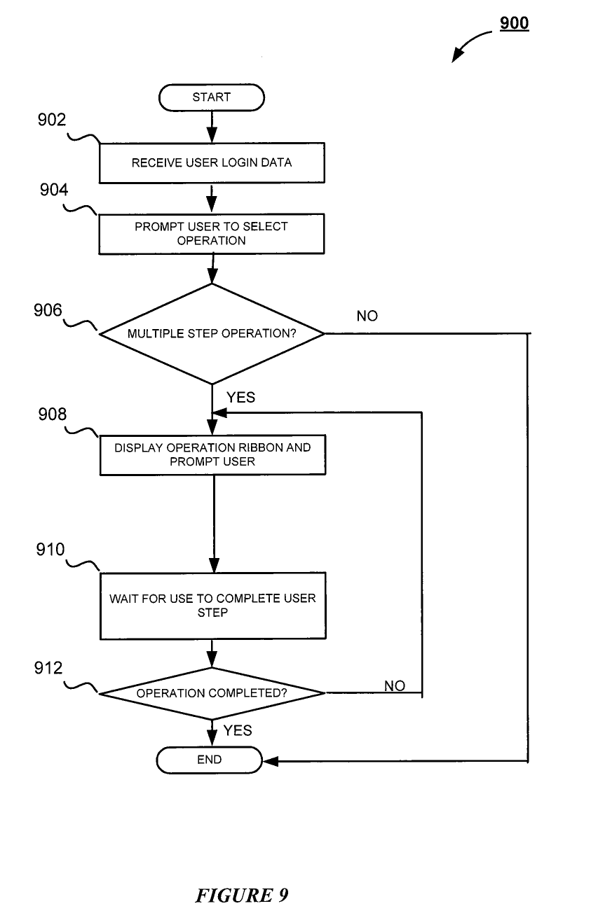

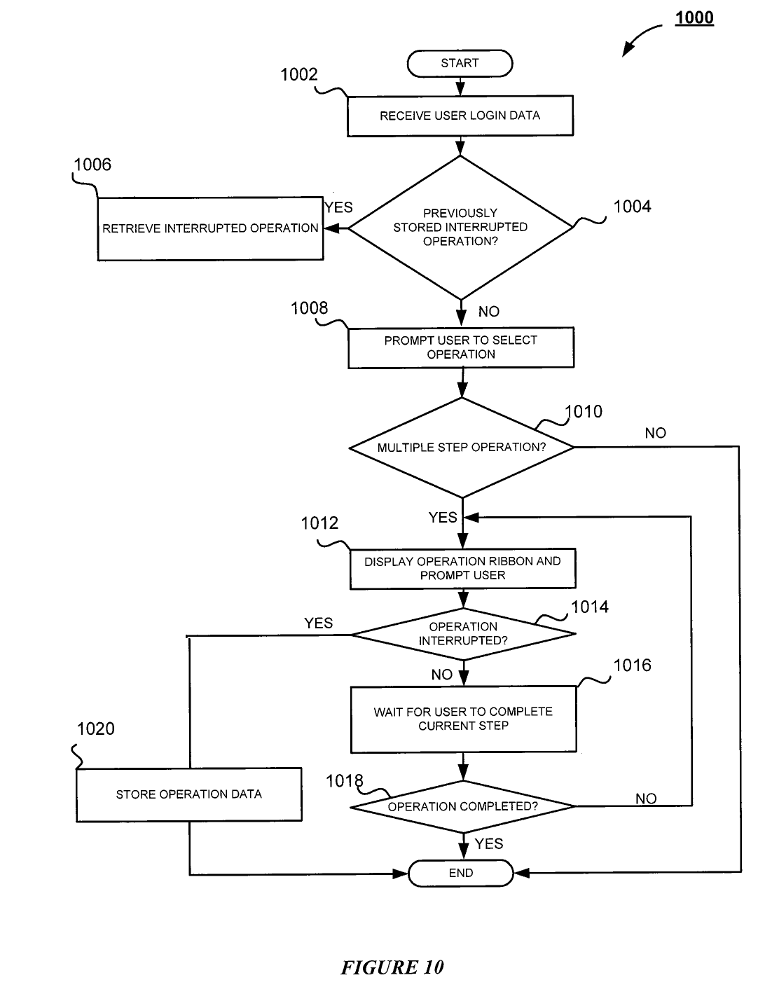

The foregoing system 100 and components described in FIG. 1, FIG. 2, FIG. 3, FIG. 4, FIG. 5, and FIG. 6 will be better understood in conjunction with the methodologies illustrated in FIG. 7, FIG. 8, FIG. 9, and FIG. 10. Referring now to FIG. 7, there is shown a flowchart 700 illustrating a method for task sequence progress tracking from the point-of-view of the document processing device 104 in accordance with one embodiment of the subject application. Beginning at step 702, the controller 108 associated with the document processing device 104 receives data representative of a multi-step document processing operation to be performed on an associated electronic document. As will be appreciated by a skilled artisan, the operation is capable of being, for example, a copy operation, a scanning operation, a facsimile operation, a print operation, or the like, as is selected by an associated user.

At step 704, the controller 108 receives progress data representative of the progress of the multi-step document processing operation on the associated electronic document, from the associated document processing device 104. Flow then proceeds to step 706, at which a linear display having multiple segments, such as the linear display band 602 shown in FIG. 6, is generated by the controller 108, displaying a graphical representation of the steps of the multi-step document processing operation on the user-interface 106. In accordance with one embodiment of the subject application, each segment of the linear display band 602 has an associated indicia representative of a step associated therewith. At step 708, the controller 108 toggles the appearance of the linear display segments on the user-interface 106 is in accordance with received progress data. At step 708, the appearance is toggled such, that an appearance of a segment, representative of a first state, such as a future step, differs from an appearance of a segment, representative of a second state, such as a current step, and differs from an appearance of a segment, representative of third state, such as a completed step.

Referring now to FIG. 8, there is shown a flowchart 800 illustrating a method for task sequence progress tracking from the point-of-view of the document processing device 108 in accordance with another embodiment of the subject application. Beginning at step 802, the controller 108 associated with the document processing device 104 receives data representative of a multi-step document processing operation to be performed on an associated electronic document. As will be appreciated by a skilled artisan, the operation is capable of being, for example, a copy operation, a scanning operation, a facsimile operation, a print operation, or the like, as is selected by an associated user.

At step 804, a selection is made of the method of generating progress data representative of progress of the multi-step document processing operation on the associated electronic document. If the selection is made at step 804 to generate progress data by an associated user, flow then proceeds to step 806. In the event of selecting an automatic method for generating progress data representative of progress of the multi-step document processing operation, flow then proceeds to step 808. Irrespective of the selected method, at step 810, the controller 108 receives progress data representative of the progress of the multi-step document processing operation on the associated electronic document.

At step 812, a linear display having multiple segments, such as the linear display band 602 shown in FIG. 6, is generated by the controller 108. In accordance with one embodiment of the subject application, the linear display corresponds to a graphical representation of the steps of the multi-step document processing operation, which is illustrated to the user via the user-interface 106. Each segment of the linear display band 602 has an associated indicia representative of a step associated therewith. Those skilled in the art will appreciate that each indicia is capable of including a verbal description of an associated step.

At step 814, the controller 108 toggles the appearance of the linear display segments on the user-interface 106 in accordance with received progress data. At step 814, the appearance of the linear display segments is toggled such, that an appearance of a segment, representative of a first state, such as a future step, differs from an appearance of a segment, representative of a second state, such as a current step, and differs from an appearance of a segment, representative of third state, such as a completed step. Further, at step 814, the appearance of the linear display segments is toggled such, the first state is a base level, the second state is a highlighted level and the third state is a dimmed level such that an appearance of a segment in first state is dominated by an appearance of a segment in the third state and wherein an appearance of a segment in the second state is dominated by an appearance of a segment in the first state, as can be seen in FIG. 6. Flow then proceeds to step 816, at which step the controller 108 selectively alters an appearance of at least one portion of a segment of the linear display band 602, is in accordance with progress through its associated step.

Referring now to FIG. 9, there is shown a flowchart 900 illustrating a method for task sequence progress tracking in accordance with another embodiment of the subject application. Beginning at step 902, the controller 108 associated with the document processing device 104 receives login data from an associated user via any suitable means. Such login data is capable of including, for example and without limitation, user ID/password, biometric data, personal identification number, or the like. The controller 108, via the associated user-interface 106, prompts the user at step 904 to select an operation. For example, a copy operation, a scanning operation, a facsimile operation, a print operation, or the like is selected by the user.

At step 906, the controller 108 determines if the operation is a multi-step operation. If the operation does not involve multiple steps, then no linear display band 602 is shown and the user orientated multi-step process ends at 914. If the process involves multiple steps then flow then proceeds to step 908, whereupon the controller 108 displays the linear display band 602 and prompts the user, via the user interface 106, to take the required actions in that step in the operation. At step 910, the controller 108, detects the required user actions. In the next step 912, the controller 108 determines if the last step was the last step of the operation. If not, the controller 108 will return to step 908, updates the ribbon indication of the current step to the next step and prompts at the user interface 106 for the user to take the required action of the next step. If at step 912 the controller 108 determines the operation is complete, then the controller 108 will terminate the user orientation operations.

Turning now to FIG. 10, there is shown a flowchart 1000 illustrating a method for method for task sequence progress tracking in accordance with in accordance with another embodiment of the subject application. Beginning at step 1002, the controller 108 associated with the document processing device 104 receives login data from an associated user via any suitable means. Such login data is capable of including, for example and without limitation, user ID/password, biometric data, personal identification number, or the like.

Next, at step 1004, the controller 108 detects if the associated user was interrupted in a previous multi-step operation. If the user was not interrupted in an earlier operation, then the controller 108 at step 1008 via the associated user-interface 106, prompts the user at step 1008 to select an operation. At step 1010, the controller 108 determines if the operation is a multi-step operation. If the operation does not involve multiple steps, then no linear display band 602 is shown and the user orientation to multi-step process ends. If the process involves multiple steps, then flow proceeds to step 1012, whereupon the controller 108 displays the linear display band 602 and prompts the user in the user interface 106 to take the required actions. At step 1014 the controller 108 determines if there was a predefined period of no user action or the user indicates he wishes to interrupt the operation.

If the operation was interrupted, then flow proceeds to step 1020 where the controller 108 will store the state of the operation and then stop the user orientation of the multi-step process. If the operation is not interrupted, then flow continues to step 1016 where the controller 108 collects that required user input at the user interface 106. In the next step 1018, the controller 108 determines if the last step was the last step of the operation. If not, the controller 108 will return to step 1012, update the ribbon indication of the current step to the next step and prompt at the user interface 106 for the user to take the required action for the next step. If at step 1018 the controller 108 determines that the operation is complete, then the controller 108 will terminate the user orientation operations.

If at step 1004, the controller 108 determines that the associated user had the previous operation interrupted, then the controller 108 will retrieve at step 1006 the interrupted operation data. Once the data is retrieved, the controller 108 will prompt the user through the user interface 106 at the step where the operation was interrupted for the required user action. Flow then continues as described above at step 1012.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A task sequence progress tracking system comprising:
means adapted for receiving data representative of a multi-step document processing operation to be performed on an associated electronic document;
means adapted for receiving, from an associated document processing device, progress data representative of progress of the multi-step document processing operation on the associated electronic document;
a linear display having a plurality of segments, each segment corresponding to a step of a multi-step document processing operation, each segment having an associated indicia representative of a step associated therewith;
means adapted for toggling an appearance of each segment from a first state, representative of a future step, to a second state representative of a current step, to a third state representative of a completed step, which toggling is in accordance with received progress data.

2. The task sequence progress tracking system of claim 1 wherein the first state is a base level, the second state is a highlighted level and the third state is a dimmed level such that an appearance of a segment in the first state is dominated by an appearance of a segment in the third state and wherein an appearance of a segment in the second state is dominated by an appearance of a segment in the first state.

3. The task sequence progress tracking system of claim 2 wherein each indicia includes a verbal description of an associated step.

4. The task sequence progress tracking system of claim 1 wherein the progress data is generated by an associated user engaging the series of steps.

5. The task sequence progress tracking system of claim 1 wherein the progress data is generated automatically by operation of the associated document processing device.

6. The task sequence progress tracking system of claim 1 further comprising means adapted for selectively altering an appearance of at least one portion of a segment in accordance with progress through its associated step.

7. A method for task sequence progress tracking comprising the steps of:
receiving data representative of a multi-step document processing operation to be performed on an associated electronic document;
receiving, from an associated document processing device, progress data representative of progress of the multi-step document processing operation on the associated electronic document;
generating a linear display having a plurality of segments, each segment corresponding to a step of a multi-step document processing operation, each segment having an associated indicia representative of a step associated therewith;
toggling an appearance of each segment from a first state, representative of a future step, to a second state representative of a current step, to a third state representative of a completed step, which toggling is in accordance with received progress data.

8. The method for task sequence progress tracking of claim 7 wherein the first state is a base level, the second state is a highlighted level and the third state is a dimmed level such that an appearance of a segment in first state is dominated by an appearance of a segment in the third state and wherein an appearance of a segment in the second state is dominated by an appearance of a segment in the first state.

9. The method for task sequence progress tracking of claim 8 wherein each indicia includes a verbal description of an associated step.

10. The method for task sequence progress tracking of claim 7 wherein the progress data is generated by an associated user engaging the series of steps.

11. The method for task sequence progress tracking of claim 7 wherein the progress data is generated automatically by operation of the associated document processing device.

12. The method for task sequence progress tracking of claim 7 further comprising the step of selectively altering an appearance of at least one portion of a segment in accordance with progress through its associated step.

13. A computer-implemented method for task sequence progress tracking comprising the steps of:
receiving data representative of a multi-step document processing operation to be performed on an associated electronic document;
receiving, from an associated document processing device, progress data representative of progress of the multi-step document processing operation on the associated electronic document;
generating a linear display having a plurality of segments, each segment corresponding to a step of a multi-step document processing operation, each segment having an associated indicia representative of a step associated therewith;
toggling an appearance of each segment from a first state, representative of a future step, to a second state representative of a current step, to a third state representative of a completed step, which toggling is in accordance with received progress data.

14. The computer-implemented method for task sequence progress tracking of claim 13 wherein the first state is a base level, the second state is a highlighted level and the third state is a dimmed level such that an appearance of a segment in first state is dominated by an appearance of a segment in the third state and wherein an appearance of a segment in the second state is dominated by an appearance of a segment in the first state.

15. The computer-implemented method for task sequence progress tracking of claim 14 wherein each indicia includes a verbal description of an associated step.

16. The computer-implemented method for task sequence progress tracking of claim 13 wherein the progress data is generated by an associated user engaging the series of steps.

17. The computer-implemented method for task sequence progress tracking of claim 13 wherein the progress data is generated automatically by operation of the associated document processing device.

18. The computer-implemented method for task sequence progress tracking of claim 13 further comprising the step of selectively altering an appearance of at least one portion of a segment in accordance with progress through its associated step.
